(19) United States
(12) Patent Application Publication
(10) Pub. No.: US 2004/0074945 A1
(43) Pub. Date: Apr. 22, 2004

(54) Spot weld robot incorporating rechargeable docking port

(76) Inventor: Joseph P. Brady, Macomb Township, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/272,772

(22) Filed: Oct. 17, 2002

(51) Int. Cl. B23K 37/00

(52) U.S. Cl. 228/44.7

(57) ABSTRACT

A system for performing a welding operation, such as a spot weld, using a robot incorporating an articulated and movable arm terminating in a weld gun. The system includes a portable and rechargeable electrical supply unit adapted to being secured to the robot arm in communicable fashion with the weld gun. The electrical supply unit includes a charging component, such as a battery, and a delivery (high capacitance/low voltage) component. A docking unit is positioned at a remote and accessible location relative the robot arm and associated supply unit, a primary voltage supply communicating with the docking unit. The electrical supply unit associated with the robot arm is electrically communicated with primary voltage input of the docking unit in a first charging condition. The robot arm is subsequently actuated to a second operating condition in which the weld gun is engaged in a welding operation and in which the delivery component supplies a low voltage, high current amperage welding current to the weld gun during a determined welding dwell time.

### BACKGROUND OF THE INVENTION

1. Field of the Invention

The present invention relates generally to weld current delivery systems, in particular the type employed on automotive assembly lines. More particularly, the present invention teaches a weld current delivery system, such as incorporated into a spot welding robot having a rechargeable docking port and which provides for iterative and alternating recharging and spot welding of such as a vehicle located on an assembly line. The advantage of doing away with the secondary circuit electrical components (i.e., electrical conduit extending to the weld head of the robot, as well as the transformer associated with the robot) is to permit greater freedom of movement and articulation of the robot arm and head during the weld cycle.

2. DESCRIPTION OF THE PRIOR ART

Spot welding techniques are well known in the art for use in such as the automotive industry. As is known, the electrode tips associated with such as a weld gun (such as further either wielded by hand or secured to an extending end of an articulated and moveable robot arm) are applied with some degree of force to opposite surfaces of the parts to be welded. At this point, a welding transformer transforms such as a primary high-voltage, low amperage power supply to a usable low-voltage, higher amperage secondary weld current.

U.S. Pat. No. 6,335,510, issued to Carbines, discloses an example of a welding robot and which, in relevant part, includes a power feed to an associated welding nozzle through a slip-ring assembly, further such that the power cable associated therewith is not required to rotate as the welding nozzle rotates during a circular welding process. Additional examples of spot weld robots, each of which incorporates the use of a welding cable and associated transformer, are disclosed in U.S. Pat. No. 4,507,534, issued to Kaumann et al., as well as U.S. Pat. No. 4,855,560, issued to Sonoda.

A perceived shortcoming of each of the previously disclosed examples of the prior art is that, while providing an effective weld robot assembly incorporating the required transformer and power cable, is the degree of freedom of movement and articulation of the robot arm is sacrificed due to the weld cable as well as further the size and arrangement of the coolant cable which is associated with the use of a larger sized weld cable. In many applications, the power and coolant cables are often three (3″) inches in diameter each, thus resulting in interference with the manipulating motion of the robot arm. It is further well known that many spot welds, such as are required in vehicle assembly, are often in fairly difficult to reach locations and which challenge the degree of unimpeded movement and articulation permitted by such robot assemblies.

A further interesting example of the prior art is the teaching of a recharge docking system for a battery powered mobile robot and such as is disclosed in U.S. Pat. No. 4,777,416, issued to George. The recharge system senses when the battery charge is below a predetermined level and, in response thereto, halts the travel of the robot at its next navigational node, following which the robot independently plots and negotiates a path from the next node back to a base nod at the recharge station, where the batteries are charged.

### SUMMARY OF THE PRESENT INVENTION

The present invention teaches a spot welding robot incorporating a rechargeable docking port and which provides for iterative and alternating recharging and spot welding of such as a vehicle located on an assembly line. As discussed previously, prior art spot welding robots require the provision of a proximate located welding transformer and secondary welding cables extending to the articulated weld gun, and the advantage of doing away with is to permit greater freedom of movement and articulation of the robot arm and head during the weld cycle.

A portable and rechargeable electrical supply unit is adapted to being secured to the robot arm in communicable fashion with the weld gun. The electrical supply unit includes a charging component, such as, in one embodiment, at least one battery, and a delivery component, such further being a high current, low voltage capacitance inducing component. A coolant supply system is also associated with the weld gun and, in one preferred variant, is provided by a water hose secured to the robot arm and in particular in proximity to the weld contacts of the weld gun.

A docking unit is provided, typically in the form of an upwardly extending structure, positioned at a remote and accessible location relative the robot arm and associated supply unit. A primary voltage supply communicates with the docking unit, such as by example typically further including a 220 V supply.

The electrical supply unit associated with the robot arm is electrically communicated with the docking unit in a first charging condition, such as by aligning and engaging contact points located on the robot arm with additional contact points associated with an appropriately configured receiving surface of the docking unit. Upon charging/recharging the portably mounted charging component, the robot arm is subsequently actuated to a second operating condition in which the weld gun is engaged in a welding operation and in which the delivery component supplies a low voltage, high current amperage welding current to the weld gun for a determined dwell time.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a first environmental view in perspective of the spot welding robot and illustrating the weld head unit with portable current transfer system in an engaged position with the portable docking unit according to the present invention;

FIG. 2 is a second environmental view, again in perspective, and illustrating the robot in an iterative and operating condition in which it is performing a spot welding operation according to the present invention; and

FIG. 3 is a further perspective illustration, in partially reduced and cutaway fashion, and illustrating the features of the welding gun, electrode cooling and current storage/delivery associated with the robot arm weld unit, as well as the 220 V primary delivery supply associated with the docking unit and its associated contact points.

### DESCRIPTION OF THE PREFERRED EMBODIMENTS

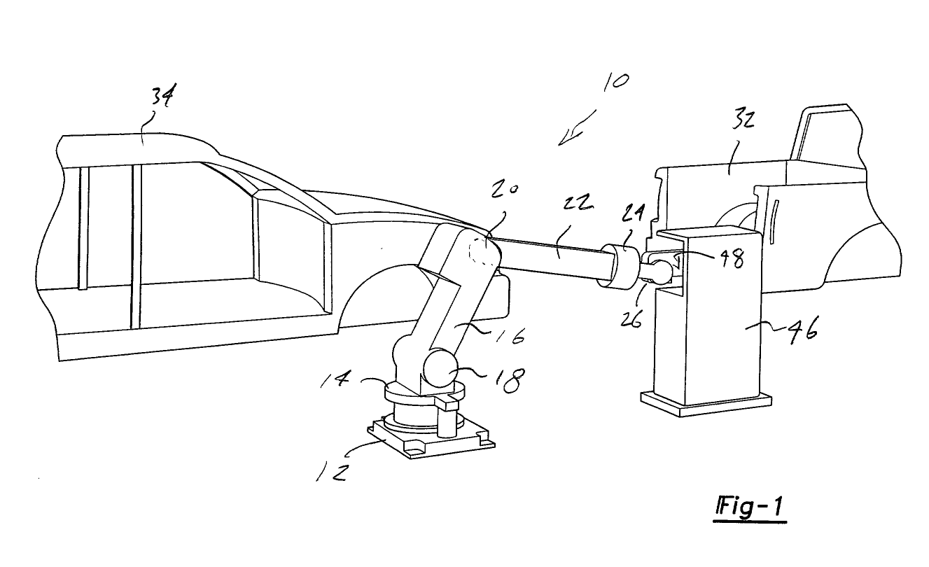

Referring now to FIG. 1, a first environmental view is illustrated in perspective at 10 of a system for performing a spot welding operation according to the present invention. The system incorporates the use of a spot welding robot including the features of a platform 12, with rotatable support 14, an upwardly extending body 16 having first lower 18 and second upper 20 articulating connections relative the extending body 16. Additional components of the weld robot include an extending arm 22 terminating in a head 24 incorporating a weld gun 26.

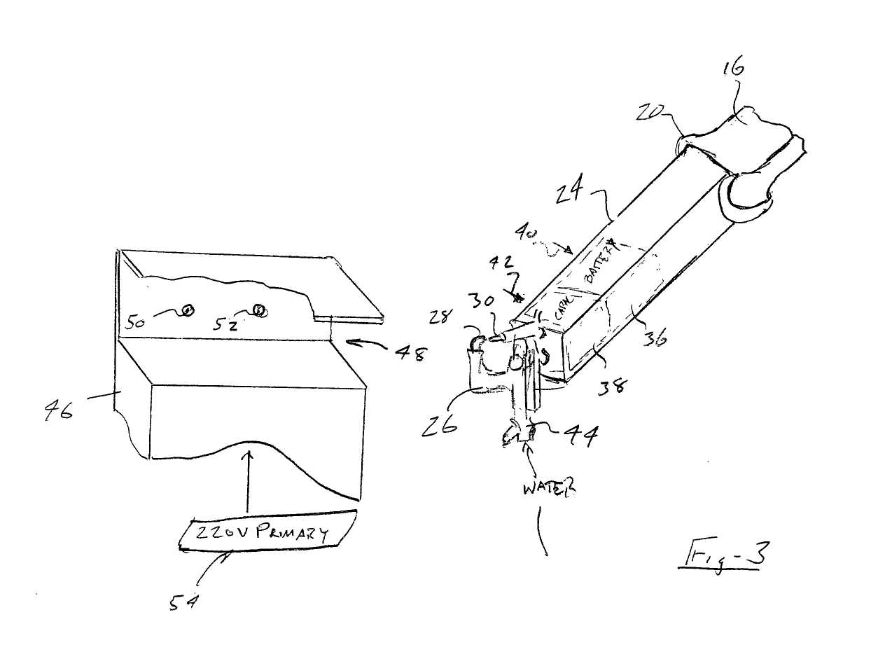

As further and best illustrated in FIG. 3, the weld gun 26 includes a pair of opposing contacts 28 and 30. As previously described, resistance spot welding techniques are fairly well known in the art and contemplate the combined application of heat, pressure and time, over a determined cycle or dwell time. Delivery of a high amperage/low voltage is provided (typically in the form of a secondary current modified from an initial high primary voltage input), from one electrode across the other, and during which the welding current encounters resistance in each of the elements of the circuit. It is during which the welding current is passes through each of these resistances that heat is generated and where the weld formation initiates.

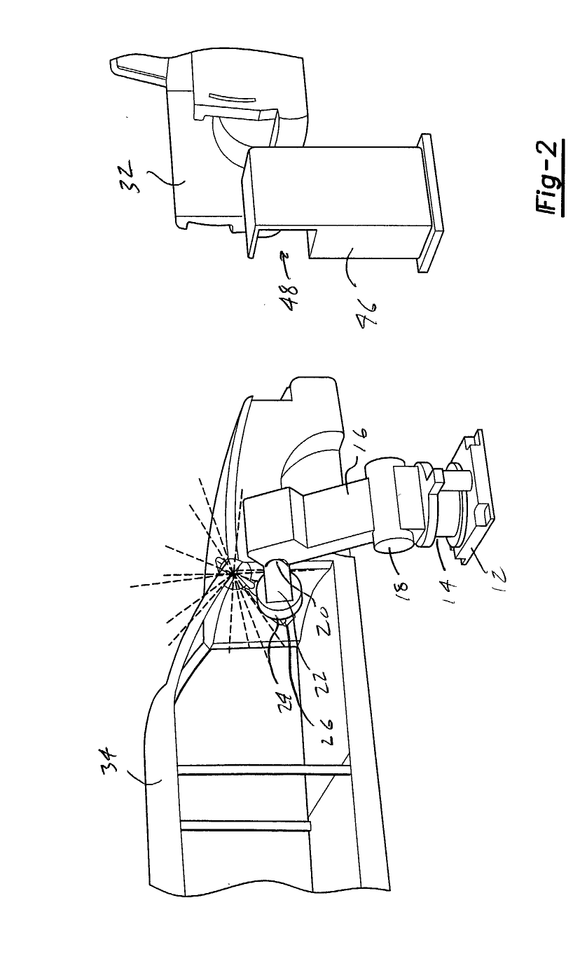

As previously described, the present invention provides the advantage of a portable current transfer system including the provision of both a current storage and delivery component associated with the robot arm, combined with a separate and accessible docking port for iteratively recharging the portable mounted component between active weld (dwell) time and non-active down time. As is also well known in the art, the typical active weld cycle (dwell time) associated in vehicle assembly spot welding operations is often no more than a few seconds, as compared to a non-active cycle of often a minute or more during which a first vehicle 32 (again FIGS. 1 and 2) advanced after welding and a succeeding vehicle 34 is positioned in place for receiving the desired spot weld.

Due to the above-discussed disparity of time between on demand and off demand of the weldment cycle, it has been determined that the provision of a portable and rechargeable current storage and delivery unit, arranged on the robot directly, and combined with a remote and accessible docking unit, provides a viable alternative to the requirement of a proximately located transformer and secondary circuit power (as well as coolant) cables extending along the robot to its associated weld gun. As again previously explained, the prior necessity of such cables is that they severely compromise the freedom of motion and articulation of the robot, particularly when attempting to position the weld gun in fairly hard to reach locations.

Referring again to FIG. 3, the portable rechargeable current storage and delivery unit is generally referenced through the combined illustration of a battery 36 and an interconnected capacitor 38. It is also envisioned that the battery 36 and capacitor 38 could be incorporated into a single unit as a combined electrical storage/delivery device. It is also envisioned that, aside from conventional battery and capacitance storage units, any and all other types of components capable of generating, storing and delivering a transient electrical (current carrying) charge is envisioned within the scope of the invention. While the present invention contemplates a variety of mounting configurations, it is generally desired that the current charging/delivery components be arranged in a location proximate to the weld gun 26 and its associated electrodes 28 and 30.

While further not specifically shown in FIG. 3, arrows 40 and 42 designate first and second contact points arranged at locations along a hidden surface of the arm 24 and in electrical communication with the storage and delivery unit. In sum, it is contemplated that the weld gun 26, the current storage and delivery components (see again at 36 and 38 in FIG. 3) and a coolant supply system (such as a water hose 44 arranged in communication with the pair of opposing contacts of the weld gun) combine to provide a weld unit according to the dictates of the present invention.

The docking unit is illustrated at 46, positioned at a remote and accessible location relative the robot and its associated arm. The docking unit 46 is typically constructed as an upwardly extending structure within which is defined an inlet 48 with additional contact points 50 and 52 (see FIG. 3) for receiving, in inserting and communicating fashion the extending robot arm and weld gun. In particular, the contact points 40 and 42 configured along the surface of the robot are positioned to align and electrically contact with those indicated at 50 and 52 of the docking unit 46.

The docking unit 46 further includes a primary voltage supply (of any desired rating, i.e. 220 V, etc.) communicating therewith and which, in a preferred application, is provided as a 220 V primary input, see at 54 in FIG. 3. It is also envisioned that the docking unit 46, as opposed to being a stand alone structure, can be configured in either overhead and wall mounted locations, or any other suitable application which takes into account the environment within which the robot is located.

As again is illustrated in FIG. 1, the storage and delivery unit associated with the robot arm and weld gun is electrically communicated with the docking unit 46 in a first charging condition, this corresponding to the previously described off demand period (potentially in the area of 30 seconds to 1 and ½ minutes) during which the vehicle 32, previously welded, is being advanced from the weld station and the succeeding vehicle 34 is being positioned for spot welding. Referencing further FIG. 2, the robot is illustrated subsequently being actuated to a second operating condition in which the weld gun 26 is engaged in a welding operation and in which the current charging and delivery unit supplies the required low voltage, high current amperage welding current to the weld gun. As is again typically known in the art, a spot weld gun of the type illustrated herein may apply a force of 500-2000 pounds (lbs) during a weldment period, and further in which an amperage in a range of 8,000 to 36,000 amps is delivered to create a specified weld thickness (such as further for example a thickness of between 0.020″ to 0.125″ between the abutting metal surfaces).

Following the welding “dwell time”, the robot arm is returned to the initial charging/recharging condition illustrated in FIG. 1, wherein the storage and delivery unit is recharged with the desired and predetermined charge of current and prepared for executing a repeating and repetitive weld cycle. In this fashion, the requirement is avoided of running the larger sized secondary circuit power cables and larger sized and associated coolant cables (often again 3″ or more each in diameter) to the weld gun at the head of the robot, thus avoiding the concurrent sacrifice of freedom of motion and articulation of the robot arm, head and gun.

Having described my invention, additional preferred embodiments will become apparent to those skilled in the art. Along these lines, it is envisioned that the weld current delivery system with rechargeable docking port could be incorporated into assemblies other than a traversable robot arm as previously described in one preferred embodiment, such further any type of articulating arm, automatic or manual (fixturing) applications and the like, and which iteratively accesses a remote and recharging docking location. Also, alternate types of coolant and means of application can be provided and which take into account the advantage provided of the reduced coolant requirements of the portable current delivery system.

I claim:

1. A system for performing a welding operation using a robot, the robot having an articulated and movable arm terminating in a weld gun, said system comprising:
a portable and rechargeable electrical supply unit adapted to being secured to the robot arm in communicable fashion with the weld gun, said electrical supply unit including a charging component and a delivery component; and
a docking unit positioned at a remote and accessible location relative the robot arm and associated supply unit, a primary voltage supply communicating with said docking unit;
the electrical supply unit associated with the robot arm being electrically communicated with said docking unit in a first charging condition, the robot subsequently being actuated to a second operating condition in which the weld gun is engaged in a welding operation and in which said delivery component supplies a low voltage, high current amperage welding current.

2. The system as described in claim 1, said docking unit further comprising an upwardly extending structure within which is defined an inlet location for receiving, in electrically communicating fashion, the electrical supply unit associated with the robot arm.

3. The system as described in claim 2, further comprising a 220V voltage supply communicated with said docking unit.

4. The system as described in claim 1, said voltage and current delivery component further comprising a portable battery and capacitor inducer.

5. The system as described in claim 1, further comprising a coolant supply system associated with the weld gun.

6. The system as described in claim 5, said coolant supply system further comprising a water hose secured to the robot arm.

7. A spot weld robot having an articulated and movable arm terminating in a weld gun, said robot comprising:
a weld unit incorporated into the arm and including a current storage and delivery unit in operative communication with the weld gun; and
a docking unit positioned at a remote and accessible location relative the robot arm and associated storage and delivery unit, a primary voltage supply communicating with said docking unit;
the storage and delivery unit being electrically communicated with said docking unit in a first charging condition, the robot arm subsequently being actuated to a second operating condition in which the weld gun is engaged in a welding operation and in which said delivery unit supplies a low voltage, high current amperage welding current to the weld gun, the robot arm subsequently returning to said first charging condition in repeating and iterative fashion during each of succeeding weld cycles.

8. The robot as described in claim 7, said current storage and delivery unit further comprising at least one battery and at least one capacitor.

9. The robot as described in claim 7, said docking unit further comprising a 220 V voltage supply.

10. The robot as described in claim 7, further comprising a water coolant line arranged in communication with a pair of opposing and electrode contacts associated with the weld gun.

11. A weld current delivery system incorporating a weld gun, said system comprising:
a portable and rechargeable electrical supply unit adapted to being secured to the delivery system in communicable fashion with the weld gun, said electrical supply unit including a charging component and a delivery component; and
a docking unit positioned at a remote and accessible location relative the delivery system and associated supply unit, a primary voltage supply communicating with said docking unit;
the electrical supply unit associated with the delivery system being electrically communicated with said docking unit in a first charging condition, the system subsequently actuating the weld gun to a second operating condition in which the gun is engaged in a welding operation and in which said delivery component supplies a low voltage, high current amperage welding current.
